(19) United States
(12) Patent Application Publication
(10) Pub. No.: US 2016/0217963 A1
(43) Pub. Date: Jul. 28, 2016

(54) PLASMA GENERATING DEVICE AND MANUFACTURING METHOD THEREOF

(71) Applicant: National Taiwan University, Taipei (TW)

(72) Inventors: Cheng-Che Hsu, Taipei (TW); Yao-Jhen Yang, Taipei (TW); Peng-Kai Kao, Taipei (TW); Tzu-Hsuan Lin, Taipei (TW); Chih-Chun Wang, Teipei (TW)

(21) Appl. No.: 14/806,977

(22) Filed: Jul. 23, 2015

(30) Foreign Application Priority Data
Jan. 23, 2015 (TW) 104102202

(51) Int. Cl. H01J 17/04; H01J 11/22; H01J 11/50; H01J 9/395; H01J 9/40; H01J 17/16; H01J 9/18

(52) U.S. Cl. CPC H01J 17/04; H01J 17/16; H01J 11/22; H01J 9/18; H01J 9/395; H01J 9/40; H01J 11/50; H01J 2209/02; H01J 2209/18

(57) ABSTRACT

The present invention provides a plasma generating device comprising a high voltage driving device, an insulated substrate, and two electrode units. The present invention further provides a manufacturing method of a plasma generating device comprising the following steps of: (1) preparing an insulated substrate with a first surface and a second surface; (2) preparing two electrode units which respectively dispose one electrode unit on the first surface and the second surface, and (3) connecting the electrode with the high voltage driving device. Compared to the prior arts, the present invention provides a simpler process to manufacture the micro plasma generating device without using delicate facilities or machine tools. The present invention has advantages of lower cost and simpler manufacturing processes.

### PRIORITY

This application claims the benefit of the filing date of Taiwan Application No. 104102202, filed Jan. 23, 2015, entitled “A PLASMA GENERATING DEVICE AND MANUFACTURING METHOD THEREOF,” and the contents of which are hereby incorporated by reference in their entirety.

### FIELD OF THE INVENTION

The present invention relates to a plasma generating device and manufacturing method thereof; more particularly, the present invention relates to a plasma generating device and manufacturing method thereof without using delicate facilities or machine tools.

### BACKGROUND

Plasma is an ionized gas composed of electrons with high energy, radicals, ions with positive charges and negative charges, and neutral gases. The plasma usually remains in a state of electro-neutrality because most regions of the plasma own equal quantity of the negative charges and the positive charges. Since there are small amounts of free electrons in the air, they are driven by external high electric fields to get the energy and become accelerated, and the electrons with high energy are collided with the air to stimulate and ionize the air to generate radicals and ions with high energy and high reactivity. As a result, the plasma is generated.

In various well-known plasma systems, the microplasma is a system of the plasma wherein at least one or more scale of the plasma is less than 1 mm. Because of the small scale, the system of the plasma comprises the features of the low operating voltage, flexible form, and so on. The shape and dimension of the pattern of the microplasma generation device is needed to be precisely defined when manufacturing the device; for example, in the lithographic process of the well-known technique, the pattern of the microplasma is defined by the pattern of the plasma generation device, and the pattern of the electrode units is manufactured by the mask of the semiconductor process or the micromachining process. In practical applications, the pattern of the microplasma is defined through complex processes.

In the prior arts, a manufacturing method of the microplasma with microchannel is disclosed in U.S. Pat. No. 8,535,110 integrating the metals and the polymer to form the microchannel or the microcavity to manufacture the microplasma generating device. In addition, the manufacturing method of the microplasma generating device manufacturing by the semiconductor lithographic process on a glass substrate is disclosed in IEEE Photon. Technol. Lett 17, page 1543 (2005). The manufacturing method of the microplasma arrays manufactured by utilizing the lithographic process and the etching process to generate patterned electrode units to form microplasma arrays generating device is disclosed in U.S. Pat. No. 8,547,004 B2. The microplasma generation device fabricated on the glass substrate requiring the lithographic process, the etching process, and coating process is disclosed in Applied Physics Letters 95, pages 111504 (2009). The microplasma generation device with the paper substrate processed by mechanical cutting and screen printing is disclosed in Journal of Microelectromechanical Systems 22, pages 256 (2013).

From the prior arts, a manufacturing method of the plasma generating device which is fast, easy, low-cost and able for designers to generate ideas in a plurality of methods is not presented. Therefore, the method of generating a microplasma with arbitrary patterns is an unsolved problem nowadays.

### BRIEF DESCRIPTION OF THE DRAWINGS

Some of the embodiments will be described in detail, with reference to the following figures, wherein like designations denote like members, wherein:

FIG. 1 is a front view of the plasma generating device of the present invention in an embodiment, and FIG. 2 is a sectional view of the plasma generating device corresponding to the line I-I in FIG. 1.

FIG. 3 is a front view of the plasma generating device of the present invention in another embodiment, and FIG. 4 is a sectional view of the plasma generating device corresponding to the line II-II in FIG. 3.

FIG. 5A to FIG. 5D are sectional views of the manufacturing in another embodiment corresponding to the line I-I in the FIG. 1.

FIG. 6A to FIG. 6D are sectional views of the manufacturing in another embodiment corresponding to the line II-II in FIG. 3.

### DETAILED DESCRIPTION

According to the disadvantages of the widely used techniques mentioned above, the present invention provides a plasma generating device and manufacturing method thereof as illustrated below.

The present invention provides a plasma generating device, comprising a high voltage driving device, an insulated substrate and two electrode units. The insulated substrate has a first surface and a second surface. The two electrode units are respectively set on the first surface and the second surface, and electrically connected to the high voltage driving device. The plasma is generated on the first surface when the electrode units are powered by the high voltage driving device.

The present invention further provides a manufacturing method of a plasma generating device, comprising the following steps of: preparing an insulated substrate, wherein the insulated substrate has a first surface and a second surface; preparing two electrode units, respectively setting on the first surface and the second surface, and connecting the electrode with the high voltage driving device.

The present invention further provides a manufacturing method of a plasma generating device, comprising the following steps of: preparing an insulated substrate which comprises a first surface with a metallic layer and a second surface; disposing an etching mask with a patterned electrode unit on the metallic layer of the first surface; setting an electrode unit on the second surface and an etching-resisted protective layer; conducting the wet etching process on the insulated substrate for etching the metallic layer of the first surface to form a pattern, and then removing the etching mask to form the patterned electrode unit; removing the etching-resisted protective layer on the second surface; and connecting the electrode with the high voltage driving device

Compared to prior arts, the present invention provides a plasma generating device and manufacturing method thereof for using simpler process and material to manufacture the plasma generating device. The present invention has advantages of lower cost and simpler manufacturing processes.

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present invention will in no way be limited to the number of constituting components, the materials thereof, the shapes thereof, the relative arrangement thereof, etc., and are disclosed simply as an example of embodiments of the present invention. Moreover, the numbers mentioned below are not limited to the numbers themselves. People working on the field of plasma are familiar with the high voltage mentioned below which is the range of the voltages needed for generating the plasma.

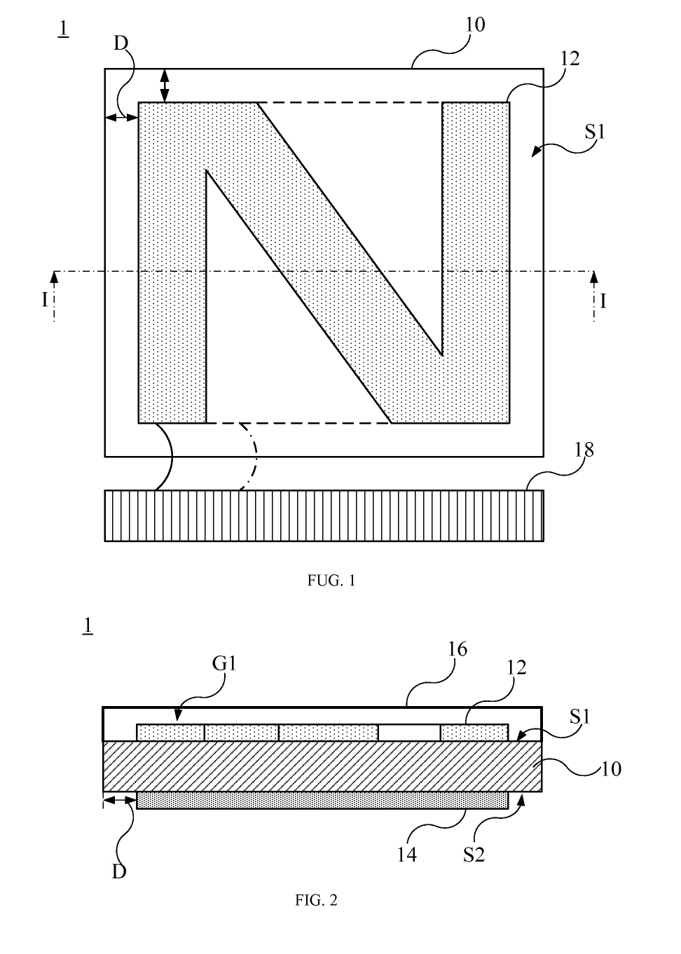

Firstly, please refer to the FIG. 1 and FIG. 2. FIG. 1 is a front view of the plasma generating device of the present invention in an embodiment, and FIG. 2 is a sectional view of the plasma generating device corresponding to the line I-I in FIG. 1.

Refer to the FIG. 1 and FIG. 2. The present invention provides a plasma generating device 1, comprising an insulated substrate 10, two electrode units 12 and 14, a cover body 16 and a high voltage driving device 18.

The insulated substrate 10 has a first surface S1 and a second surface S2. Two electrode units 12 and 14 are set on the first surface S1 and the second surface S2, respectively, and electrically connected to the high voltage driving device 18. When the electrode units 12 and 14 are powered by the high voltage driving device 18, the plasma is generated on the first surface S1, wherein a pattern corresponds to the electrode unit 12. The cover body 16 for covering the first surface S1 to form an enclosed space G1 to be filled with at least one kind of gas such as helium, neon, argon, nitrogen, oxygen, air and carbon tetrafluoride, wherein the pressure of the enclosed space is between 0.1 atm and 3 atm.

In the present invention, the cover body 16 is selective to be installed on the first surface S1 only, on the first surface S1 and the second surface S2 simultaneously, or not to be installed; if the cover body 16 is not to be installed, the plasma generated by the plasma generating device 1 is an air plasma.

The material of the insulated substrate 10 is selected from a group comprising silicon dioxide, glass fiber, aluminum oxide, polyethylene terephthalate, acrylonitrile butadiene styrene copolymer, polystyrene, polyimide, polytetrafluoroethene, polyvinyl chloride, phenolic resins, polypropylene, the poly(L-lactide), acrylonitrile-styrene copolymer, polymethylmethacrylate, cellulose acetate, polyamide, polyamide-imide, polybutylene terephthalate, polycarbonate, polyethylene, polyoxymethylene, polyurethane and any combination thereof, and the definition of the insulation of the insulated substrate 10 is that the electric resistivity is more than 1,000 Ω-m. The material of the insulated substrate 10 is a glass substrate in the embodiment.

A voltage difference generated from the high voltage driving device 18 is at least 200 volt, a frequency of the output voltage of the pulsed electrical power or an AC power is between 100 Hz and 1,000,000 Hz.

Refer to the FIG. 1 and FIG. 2; a pitch D between the outer edge of the electrode units 12 and 14 and the outer edge of the insulated substrate 10 is between 2 mm and 10 mm to avoid the occurrence of short circuit on the insulated substrate 10 when the electrode units 12 and 14 are powered; the pitch D is longer than 2 mm in the embodiment.

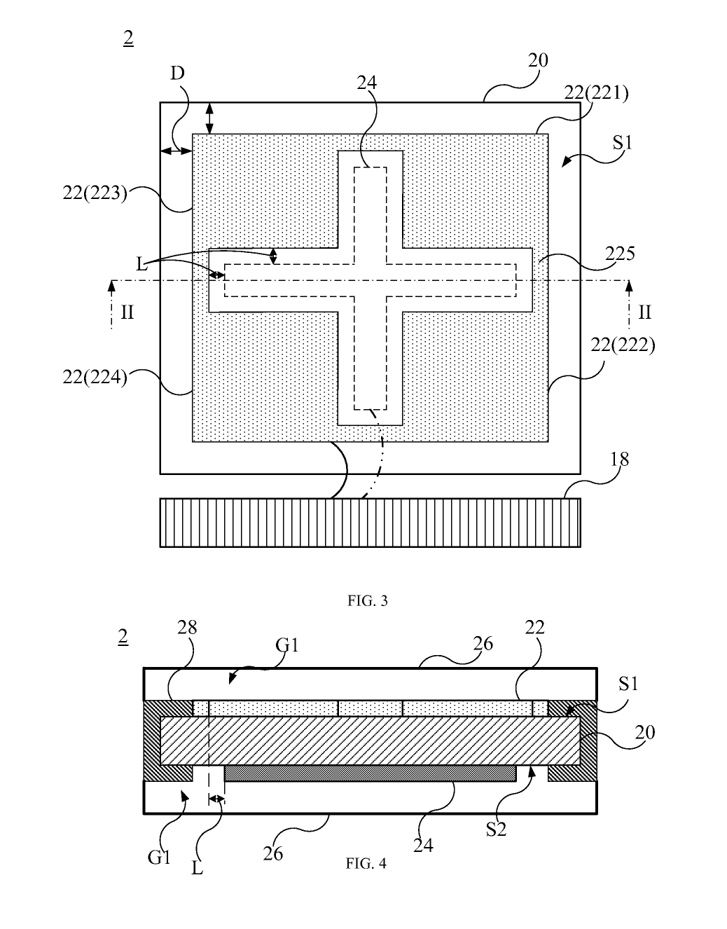

Please refer to the FIG. 1, FIG. 3 and FIG. 4. FIG. 3 is a front view of the plasma generating device of the present invention in another embodiment, and FIG. 4 is a sectional view of the plasma generating device corresponding to the line II-II in the FIG. 3. Refer to FIG. 3 and FIG. 4, the present invention provides a plasma generating device 2 comprising an insulated substrate 20, two electrode units 22 and 24, a cover body 26, a high voltage driving device 18 and an insulated packaging material 28.

Please refer to FIG. 1 and FIG. 3. The electrode units of the present invention comprise two types: an integrated electrode unit 12 shown in the FIG. 1 and a discrete electrode unit 22 comprising discrete electrode units 221 to 224 and a connector 225. The connector 225 is electrically connected to each discrete electrode units 221 to 224. The integrated electrode unit 12, the discrete electrode units 221 to 224 and the discrete electrode unit 22 form a pattern likes the letter N in FIG. 1 or a hollow cross in FIG. 2 respectively.

Please refer to FIG. 3. A pitch L in the collateral direction of the first surface S1 between the inter edge of the electrode unit 22 of the first surface S1 and the outer edge of the electrode unit 24 of the second surface S2 is between 2 mm and 10 mm to generate more stable plasmas on the first surface S1 and second surface S2; the pitch L is 2 mm in the embodiment. The present invention further comprises an insulated packaging material 28 disposed on an outer edge of the plasma generating device 2 selectively in the embodiment to avoid the occurrence of the short circuit on the outer edge of the insulated substrate 20 when the electrode units 22 and 24 are powered.

In the present invention, the manufacturing method of the electrode units 12, 14, 22 (221 to 224) and 24 comprise the following steps of: coating a pattern by conductive glue, conductive slurry or conductive paint; attaching the pattern with a cut conductive copper tape and a cut conductive carbon tape with a pattern; or utilizing the toner transfer or lithographic process to define an etching-resistive mask with a patterned electrode unit on an metallic layer, and then etching away the metal not protected by the mask pattern by etching process. The material of the electrode units 12, 14, 22 (221 to 224) and 24 are selected from a group comprising carbon, copper, silver, ferrous, cobalt, nickel, stainless steel, zinc, titanium, conductive carbon paint, conductive cooper paint, conductive silver paint, conductive copper tape, conductive carbon tape and any combination thereof.

The present invention provides a manufacturing method of the plasma generating device 1 and 2 comprising the following steps of: preparing an insulated substrate which comprises a first surface and a second surface; preparing two electrode units for being installed the electrode units on the first surface and the second surface; and connect the electrode with the high voltage driving device.

Please refer to FIG. 1 to FIG. 4. The manufacturing method of the plasma generating device 1 and 2 in two embodiments of the present invention comprises the following steps of: preparing the insulated substrates 10 and 20 having the first surface S1 and the second surface S2; setting the electrode units 12, 14, 22 and 24 on the first surface S1 and the second surface S2; preparing the high voltage driving device 18 and electrically connecting the high voltage driving device 18 to the electrode units 12, 14, 22 and 24 to form plasma generating devices 1 and 2.

The manufacturing method of the plasma generating devices 1 and 2 further comprises following steps of: utilizing the cover body for covering the first surface to form an enclosed space; and fill the space with at least one kind of gas such as helium, neon, argon, nitrogen, oxygen, air and carbon tetrafluoride, wherein the pressure of the enclosed space is between 0.1 atm and 3 atm.

The cover body 16 is selectively disposed on the first surfaceS1, on the second surface S2, on the first surface S1 and the second surface S2 simultaneously or not to be disposed. An enclosed space G1 is formed between the cover body 16 and the first surface S1, and filled at least one kind of gas such as helium, neon, argon, nitrogen, oxygen, air and carbon tetrafluoride into the enclosed space G1, wherein the pressure of the enclosed space G1 is between 0.1 atm and 3 atm. If the cover body 16 is not to be installed, the plasma generated by the plasma generating device 1 is an air plasma.

The manufacturing method of the plasma generating device1 and 2, further comprises the following steps of: disposing an insulated packaging material for covering an outer edge of the plasma generating device, and selectively disposing the insulated packaging material 28 on the outer edge of the insulated substrates 10 and 20 of the plasma generating device 1 and 2 to avoid the occurrence of short circuit on the outer edge of the insulated substrate 20 when the electrode units 22 and 24 are powered.

The material of the insulated substrate 10 and 20, the material and the manufacturing method and material of the electrode units 12, 14, 22 (221 to 224) and 24, the pitch D between the an outer edge of the electrode units 12, 14, 22 (221 to 224) and 24 and an outer edge of the insulated substrates 10 and 20, the pitch L in the collateral direction of the first surface S1 between an inter edge of the electrode units 12 and 22 of the first surface S1 and an outer edge of the electrode units 14 and 24 of the second surface S2, and the parameters of the high voltage driving device 18 are previously mentioned; hence, they will not be described in further detail.

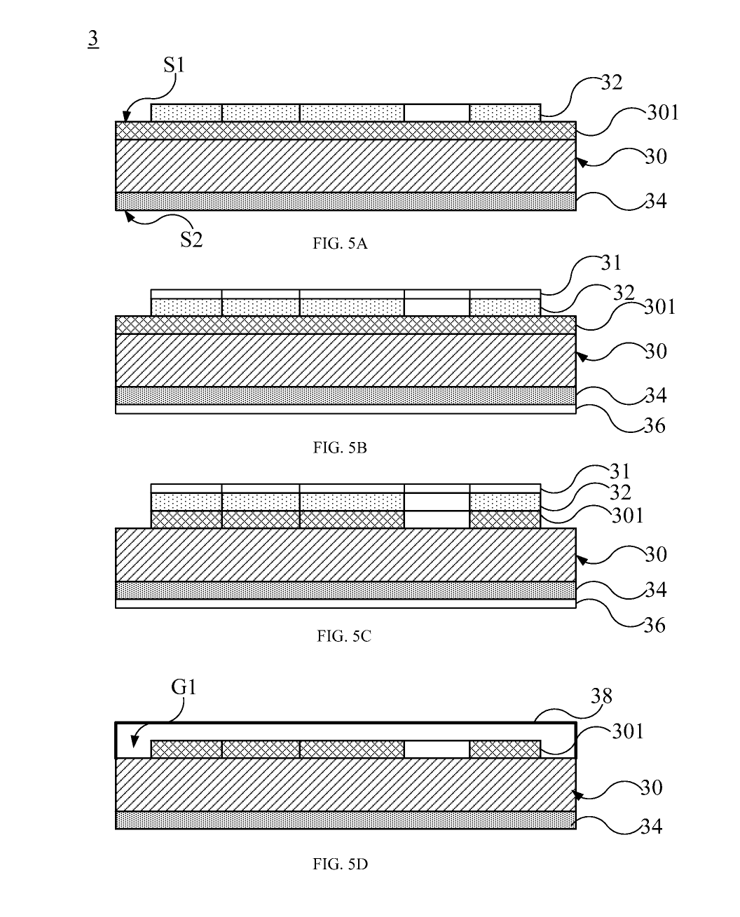

Please refer to FIG. 1 and FIG. 5A to FIG. 5D. FIG. 5A to FIG. 5D are sectional views of the manufacturing in another embodiment corresponding to the line I-I in the FIG. 1. The present invention provides the manufacturing method of the plasma generating device 3, comprising the following steps of: preparing an insulated substrate, wherein the insulated substrate comprises a first surface having metallic layer and a second surface; disposing an etching mask on the metallic layer of the first surface, wherein the etching mask has a patterned electrode unit; setting an electrode unit on the second surface, and disposing an etching-resisted protective layer for covering the second surface and the electrode unit; conducting a wet etching process on the insulated substrate for etching the metallic layer of the first surface to form a pattern, and then removing the etching mask to form the patterned electrode unit; removing the etching-resisted protective layer on the second surface; and connecting the electrode with the high voltage driving device

The sequence of the steps of the manufacturing method of the plasma generating device 3 is not limited to the sequence of the steps mentioned above. The user is able to change the sequence of the steps. Please refer to FIG. 5A and FIG. 5B. The manufacturing method comprising the following steps of: preparing an insulated substrate 30, wherein the insulated substrate 30 comprises a first surface S1 having a metallic layer 301 and a second surface S2; disposing an etching mask 32 on the metallic layer 301 of the first surface S1, wherein the etching mask 32 has a patterned electrode unit; disposing an electrode unit on the second surface S2, and disposing an etching-resisted protective layer 36 for covering the second surface S2 and the electrode unit. Moreover, the manufacturing method of the plasma generating device 3 of the present invention, further comprises the following steps of: disposing an etching-resisted protective layer 31 on the metallic layer 301 of the first surfaceS1, wherein the etching-resisted protective layer 31 is utilized to avoid the etching liquid penetrating the etching mask 32 on the metallic layer 301 while conducting the wet etching process.

Please refer to FIG. 5C. The following steps can be conducted as follows: conducting a wet etching process on the insulated substrate 30 for etching the metallic layer 301 of the first surface S1 to form a pattern. Then refer to FIG. 5D, the following steps can be conducted as follows: removing the etching mask 32 to form the patterned electrode unit 301; removing the etching-resisted protective layer 36 on the second surface S2; and connecting the electrode unit 34 and the patterned unit 301 with the high voltage driving device.

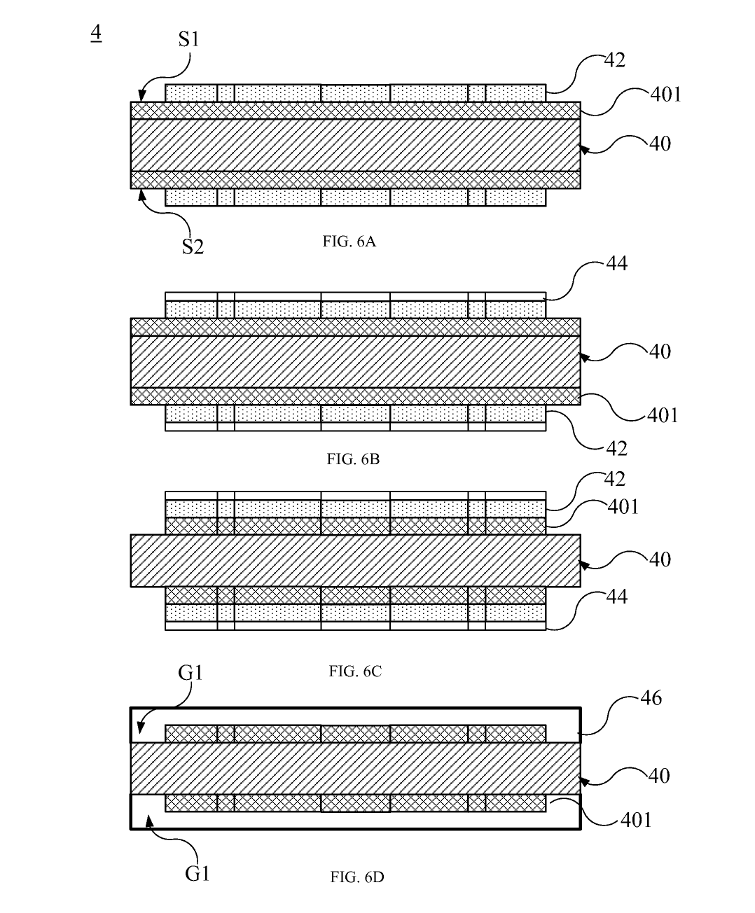

Please refer to FIG. 6A to FIG. 6D. FIG. 6A to FIG. 6D are sectional views of the manufacturing in another embodiment corresponding to the line II-II in the FIG. 3. The manufacturing method of the plasma generating device 4 in the embodiment is obtained by referring to the manufacturing method of the plasma generating device 3.

Please refer to FIG. 6A and FIG. 6B. The manufacturing method of the plasma generating device 4 comprises the following steps of: preparing an insulated substrate 40, wherein the insulated substrate 40 comprises a first surface S1 having a metallic layer 401 and a second surface S2; disposing an etching mask 42 on the metallic layer 401 of the first surface S1, wherein the etching mask 42 has a patterned electrode unit. Moreover, the manufacturing method of the plasma generating device 4 of the present invention further comprises the following steps of: disposing an etching-resisted protective layer 44 on the metallic layer 401 of the first surface S1 and the second surface S2, wherein the etching-resisted protective layer 44 is utilized to avoid the etching liquid penetrating the etching mask 42 on the metallic layer 401 while conducting the wet etching process.

Please refer to FIG. 5C. The following steps can be conducted as follows: conducting a wet etching process on the insulated substrate 40 for etching the metallic layer 401 of the first surface S1 to form a pattern. Then, refer to FIG. 5D. The following steps can be conducted as follows: removing the etching mask 42 to form the patterned electrode unit 401 and connecting the electrode unit 401 with the high voltage driving device.

The manufacturing method of the plasma generating devices 3 and 4 further comprises the following steps of: preparing a cover body for packaging the first surface to form an enclosed space; and filling at least one kind of gas such as helium, neon, argon, nitrogen, oxygen, air and carbon tetrafluoride into the enclosed space, wherein a pressure of the enclosed space is between 0.1 atm and 3 atm.

The cover bodies 38 and 46 are selectively disposed on the first surfaceS1, on the second surface S2, on the first surface S1 and the second surface S2 simultaneously or not be disposed. An enclosed space G1 is formed between the cover body 16 and the first surface S1, and filled at least one kind of gas such as helium, neon, argon, nitrogen, oxygen, air and carbon tetrafluoride into the enclosed space G1, wherein the pressure of the enclosed space G1 is between 0.1 atm and 3 atm. However, if the cover bodies 38 and 46 are not be installed, the plasma generated by the plasma generating devices 3 and 4 are an air plasma. Additionally, the manufacturing method of the electrode units 301, 401 and 34 comprises following steps of: coating the pattern by conductive glue, conductive slurry, or conductive paint; attaching the pattern with the cut conductive copper tape or the cut conductive carbon tape; or utilizing the toner transfer or lithographic process to define an etching-resistive masks 32 and 42 on an metallic layer, and then etching away the metal not protected by the masks 32 and 42 to produce the desired pattern by etching process. The material of the electrode units 301, 401 and 34 is selected from a group comprising carbon, copper, silver, ferrous, cobalt, nickel, stainless steel, zinc, titanium, conductive carbon paint, conductive cooper paint, conductive silver paint, conductive copper tape, conductive carbon tape and any combination thereof.

The material of the insulated substrate 30 and 40, the pitch D between the an outer edge of the electrode units 301 and 401 and 34 and an outer edge of the insulated substrates 30 and 40, the pitch L in the collateral direction of the first surface S1 between an inter edge of the electrode units 301 and 401 of the first surface S1 and an outer edge of the electrode units 34 and 401 of the second surface S2, the insulated material of the insulated material and the parameters of the high voltage driving device 18 are mentioned above and hence will not be described in further detail.

From the above mentioned, the present invention provides a manufacturing method of the plasma generating device obtained by disposing an electrode unit on one side of the insulated substrate and disposing the other electrode unit on the other side of the insulated substrate. The plasma is generated on the insulated substrate when two electrode units are powered and the pattern is corresponded to the electrode unit. The manufacturing method of the electrode unit, further comprises the following steps of: coating the pattern by conductive glue, conductive slurry, or conductive paint; attaching the pattern with the cut conductive copper tape or the cut conductive carbon tape; or utilizing the toner transfer or lithographic process to define an etching-resistive masks 32 and 42 on an metallic layer, and then etching away the metal not protected by the masks 32 and 42 to produce the desired pattern by etching process, or disposing an electrode unit or generating the patterned electrode unit when the patterned electrode unit is generated on at least one side or two sides of the copper layer for the printed circuit boards to obtain the plasma generating device. Finally, the patterned electrode unit is generated on the insulated substrate when two electrode units are powered.

Compared to prior arts, the present invention provides a simpler process to manufacture the plasma generating device without using precisely facilities or machine tools. The present invention has advantages of lower cost and simpler manufacturing processes.

With the examples and explanations mentioned above, the features and spirits of the invention are hopefully well described. More importantly, the present invention is not limited to the embodiment described herein. Those skilled in the art will readily observe that numerous modifications and alterations of the device may be made while retaining the teachings of the invention. Accordingly, the above disclosure should be construed as limited only by the meets and bounds of the appended claims.

1. A plasma generating device, comprising:
a high voltage driving device;
an insulated substrate, having a first surface and a second surface; and
two electrode units, respectively set on the first surface and the second surface and electrically connected the to the high voltage driving device;
wherein when the electrode units are powered by the high voltage driving device, the plasma is generated on the first surface.

2. The plasma generating device of claim 1, wherein each electrode unit is an integrated electrode unit.

3. The plasma generating device of claim 1, wherein the electrode units comprise a plurality of discrete electrode units and a plurality of connectors for electrically connecting the discrete electrodes to each other.

4. The plasma generating device of claim 1, wherein a voltage difference generated from the high voltage driving device is at least 200 volt, the high voltage driving device is a pulsed electrical power or an AC power with a frequency of an output voltage between 100 Hz and 1,000,000 Hz, and the electrical resistivity of the insulated substrate is higher than 1,000 Ω-m.

5. The plasma generating device of claim 1, wherein the distance between the outer edge of the electrode units and an outer edge of the insulated substrate is between 2 mm and 10 mm.

6. The plasma generating device of claim 1, further comprising insulated packaging materials for covering an outer edge of the insulated substrate.

7. The plasma generating device of claim 1, wherein a pitch in the collateral direction of the first surface between an inter edge of the electrode unit of the first surface and an outer edge of the electrode unit of the second surface is between 2 mm and 10 mm.

8. The plasma generating device of claim 1, wherein the material of the insulated substrate is selected from a group comprising silicon dioxide, glass fiber, aluminum oxide, polyethylene terephthalate, acrylonitrile butadiene styrene copolymer, polystyrene, polyimide, polytetrafluoroethene, polyvinyl chloride, phenolic resins, polypropylene, poly(L-lactide), acrylonitrile-styrene copolymer, polymethylmethacrylate, cellulose acetate, polyamide, polyamide-imide, polybutylene terephthalate, polycarbonate, polyethylene, polyoxymethylene, polyurethane and any combination thereof.

9. The plasma generating device of claim 1, wherein the material of the electrode units is selected from a group comprising carbon, copper, silver, ferrous, cobalt, nickel, stainless steel, zinc, titanium, conductive carbon paint, conductive cooper paint, conductive silver paint, conductive copper tape, conductive carbon tape and any combination thereof.

10. The plasma generating device of claim 1, further comprising a cover body for covering the first surface to form an enclosed space to be filled with at least one of helium, neon, argon, nitrogen, oxygen, air and carbon tetrafluoride, wherein a pressure of the enclosed space is between 0.1 atm and 3 atm.

11. A manufacturing method of a plasma generating device, comprising the following steps of:
preparing an insulated substrate, wherein the insulated substrate comprises a first surface and a second surface;
preparing two electrode units for being disposed on the first surface and the second surface respectively; and
connecting the electrode with the high voltage driving device.

12. The manufacturing method of a plasma generating device of claim 11, further comprising the following steps of:
preparing a cover body for packaging the first surface to form an enclosed space; and
filling at least one of helium, neon, argon, nitrogen, oxygen, air and carbon tetrafluoride into the enclosed space, wherein a pressure of the enclosed space is between 0.1 atm and 3 atm.

13. The manufacturing method of the plasma generating device of claim 11, wherein the electrode unit is an integrated electrode unit.

14. The manufacturing method of the plasma generating device of claim 11, wherein the electrode units comprise a plurality of discrete electrode units and a plurality of connectors for enabling the discrete electrodes to electrically connect to each other.

15. The manufacturing method of the plasma generating device of claim 11, wherein the distance between an outer edge of the electrode unit and an outer edge of the insulated substrate is between 2 mm and 10 mm.

16. The manufacturing method of the plasma generating device of claim 11, further comprising the following step of:
disposing an insulated packaging material for covering an outer edge of the plasma generating device.

17. The manufacturing method of the plasma generating device of claim 11, wherein the pitch in the collateral direction of the first surface between an inter edge of the electrode unit of the first surface and an outer edge of the electrode unit of the second surface is between 2 mm and 10 mm.

18. The manufacturing method of the plasma generating device of claim 11, wherein the material of the insulated substrate is selected from a group comprising silicon dioxide, glass fiber, aluminum oxide, polyethylene terephthalate, acrylonitrile butadiene styrene copolymer, polystyrene, polyimide, polytetrafluoroethene, polyvinyl chloride, phenolic resins, polypropylene, poly(L-lactide), acrylonitrile-styrene copolymer, polymethylmethacrylate, cellulose acetate, polyamide, polyamide-imide, polybutylene terephthalate, polycarbonate, polyethylene, polyoxymethylene, polyurethane and any combination thereof.

19. The manufacturing method of the plasma generating device of claim 11, wherein the method for manufacturing the electrode unit comprises the following steps of:
coating a pattern by conductive glue, conductive slurry or conductive paint; and
attaching the pattern with a cut conductive copper tape or a cut conductive carbon tape.

20. The manufacturing method of the plasma generating device of claim 11, wherein a voltage difference generated from the high voltage driving device is at least 200 volt, the high voltage driving device is a pulsed electrical power or an AC power with a frequency of an output voltage between 100 Hz and 1,000,000 Hz, and the electrical resistivity of the insulated substrate is higher than 1,000 Ω-m.

21. The manufacturing method of the plasma generating device of claim 11, wherein the material of the electrode unit is selected from a group comprising carbon, copper, silver, ferrous, cobalt, nickel, stainless steel, zinc, titanium, conductive carbon paint, conductive cooper paint, conductive silver paint, conductive copper tape and conductive carbon tape.

22. A manufacturing method of a plasma generating device, comprising the following steps of:
preparing an insulated substrate, wherein the insulated substrate comprises a first surface with a metallic layer and a second surface;
disposing an etching mask on the metallic layer of the first surface, wherein the etching mask has a patterned electrode unit;
setting an electrode unit on the second surface, and disposing an etching-resisted protective layer for covering the second surface and the electrode unit;
conducting a wet etching process on the insulated substrate for etching the metallic layer of the first surface to form a pattern, and then removing the etching mask to form the patterned electrode unit;
removing the etching-resisted protective layer from the second surface; and
connecting the electrode with the high voltage driving device

23. The manufacturing method of the plasma generating device of claim 22, further comprising the following steps of:
preparing a cover body for packaging the first surface to form an enclosed space; and
filling at least one of helium, neon, argon, nitrogen, oxygen, air and carbon tetrafluoride into the enclosed space, wherein a pressure of the enclosed space is between 0.1 atm and 3 atm.

24. The manufacturing method of the plasma generating device of claim 22, wherein the distance between an outer edge of the electrode unit and an outer edge of the insulated substrate is between 2 mm and 10 mm.

25. The manufacturing method of the plasma generating device of claim 22, further comprising the following step of:
disposing an insulated packaging material for covering an outer edge of the plasma generating device.

26. The manufacturing method of the plasma generating device of claim 22, wherein the inter edge pitch between an inter edge of the electrode unit of the first surface and an outer edge of the electrode unit of the second surface is between 2 mm and 10 mm.

27. The manufacturing method of the plasma generating device of claim 22, wherein the material of the insulated substrate is selected from a group comprising silicon dioxide, glass fiber, aluminum oxide, polyethylene terephthalate, acrylonitrile butadiene styrene copolymer, polystyrene, polyimide, polytetrafluoroethene, polyvinyl chloride, phenolic resins, polypropylene, poly(L-lactide), acrylonitrile-styrene copolymer, polymethylmethacrylate, cellulose acetate, polyamide, polyamide-imide, polybutylene terephthalate, polycarbonate, polyethylene, polyoxymethylene, polyurethane and any combination thereof.

28. The manufacturing method of the plasma generating device of claim 22, wherein a voltage difference generated from the high voltage driving device is at least 200 volt, the high voltage driving device is a pulsed electrical power or an AC power with a frequency of an output voltage 100 Hz to 1,000,000 Hz, and the electrical resistivity of the insulated substrate is higher than 1,000 Ω-m.

29. The manufacturing method of the plasma generating device of claim 22, wherein the disposing methods for the etching mask comprise a toner transfer and a lithographic process.

30. The manufacturing method of the plasma generating device of claim 22, wherein the patterned electrode unit and the material of the electrode units is selected from a group comprising carbon, copper, silver, ferrous, cobalt, nickel, stainless steel, zinc, titanium, conductive carbon paint, conductive cooper paint, conductive silver paint, conductive copper tape, conductive carbon tape and any combination thereof.
